(19) United States
(12) Patent Application Publication
(10) Pub. No.: US 2024/0188574 A1
(43) Pub. Date: Jun. 13, 2024

(54) FOOD PRODUCT HAVING CRUNCHY TEXTURE

(71) Applicant: Schwan's Global Supply Chain, Inc., Marshall, MN (US)

(72) Inventors: Steven Mark Leicht, Union, KY (US); Michelle Ruth Heid, Cincinnati, OH (US); Pradyot Kumar Ghosh, Mason, OH (US); Ashley Nichole Hensley, Aurora, IN (US); David Zion Ovadia, Marshall, MN (US)

(21) Appl. No.: 18/539,939

(22) Filed: Dec. 14, 2023

Related U.S. Application Data
(63) Continuation of application No. 14/860,810, filed on Sep. 22, 2015, now abandoned.
(60) Provisional application No. 62/087,103, filed on Dec. 3, 2014.
(60) Provisional application No. 62/054,785, filed on Sep. 24, 2014.

(51) Int. Cl. A21D 13/60; A21D 13/20; A21D 13/22; A21D 13/26; A21D 13/41; A21D 13/44; A21D 13/80; A21D 15/08

(52) U.S. Cl. CPC A21D 13/60; A21D 13/20; A21D 13/22; A21D 13/26; A21D 13/41; A21D 13/44; A21D 13/80; A21D 15/08

(57) ABSTRACT

A food composition capable of maintaining a crunchy texture after freezing and reheating is disclosed. The food composition includes a crust or an outer casing having a dough-based matrix or a batter-based matrix with a thickness of about 2 to about 150 mm, and texture modifying particles dispersed throughout the matrix. The texture modifying particles generally comprise about 12 to about 40% by weight of the food composition and provide the food composition with a crunchy texture. The texture modifying particles may be crushed particles of food products, such as fried grain chips, fried vegetable chips, extruded cereals, extruded crackers, or combinations thereof.

### CROSS REFERENCE TO RELATED APPLICATIONS

This application is a continuation of U.S. application Ser. No. 14/860,810 filed Sep. 22, 2015, which claims the benefit of U.S. Provisional Application No. 62/054,785 filed Sep. 24, 2014 and U.S. Provisional Application No. 62/087,103 filed Dec. 3, 2014, the disclosures of which are hereby incorporated in their entirety.

### FIELD

The present disclosure relates to food products, formulations thereof, and methods for making the same. Particularly the present disclosure relates to formulations for lending a crunchy texture to food products.

### BACKGROUND

Prepared food products and snack foods, including frozen foods that can be heated in the oven or microwave oven, are popular with consumers. The texture of a food is important for the mouth feel and appeal of the food, and consumers typically are particularly drawn to crispy and crunchy textures. However, frozen foods can suffer from problems with texture, when moisture penetrates the food (e.g., during preparation or storage) and causes the food to lose its crunchy or crispy texture. In particular, baked and fried foods that include a high-moisture sauce, a high-moisture dough, a high-moisture batter, or a high-moisture filling are susceptible to losing their desired texture during freezing, thawing, and/or finish baking or frying of the food product. Fried and frozen products are often reheated by consumers at home or at a workplace in a conventional or microwave oven. In this way, they often lose the desirable crunchy texture usually possessed directly after frying. It would therefore be beneficial to provide for a dough-based or batter-based food product that is capable of retaining moisture sensitive textural attributes, such as crunchiness, particularly during freezing, thawing and finish baking.

### SUMMARY

The present disclosure relates to formulations for a food product, particularly a dough-based food product such as pizza crust or a flat bread, or a batter-based food product, such as a pancake, or the outer casing of a roll (e.g., a Chinese spring roll, egg roll, or other filled roll or wrap), having a crunchy texture. The food product generally comprises a crust or an outer casing having a dough-based matrix or a batter-based matrix, with a thickness of about 1 to about 150 mm, and texture modifying particles dispersed throughout the matrix. The texture modifying particles typically comprise about 12 to about 40% by weight of the food composition and provide the food composition with a crunchy texture. The texture modifying particles may be crushed particles of food products, such as fried grain chips, fried vegetable chips, extruded cereals, extruded crackers, or combinations thereof. In some examples the food composition comprises about 24 to 44% flour, about 22 to 38% water; about 13 to 24% texture modifying particles; about 0.5 to 2.9% oil; and about 2.0 to 8.0% hard fat by weight. The food product may be, for example, a par baked pizza or pie crust, a bread loaf, a par baked loaf, a cookie, a calzone, an outer casing of a roll, a pancake, or a coating of a battered and fried food, that is able to maintain a crunchy texture after freezing and reheating.

### BRIEF DESCRIPTION OF DRAWINGS

FIGS. 1A and 1B are schematic cross sectional views of a food product according to embodiments.

FIG. 1C is a schematic of a process according to an embodiment.

FIG. 1D is a schematic of a process according to an embodiment.

FIGS. 2A-2E are flow diagrams of the methods of preparing the food product of FIGS. 1A and 1B according to an embodiment.

FIG. 3 is a graph of texture analyzer test results of a food product according to an embodiment and a comparative sample.

FIG. 4 is a schematic cross sectional view of a food product according to an embodiment.

FIG. 5A is a schematic top view of a food product according to an embodiment.

FIG. 5B is a schematic cross sectional view of the food product of FIG. 5A.

FIGS. 6A and 6B are schematic cross sectional views of food products according to embodiments.

FIG. 7 is a graph of expert panel test results of a food product according to an embodiment and a comparative sample.

### DETAILED DESCRIPTION

The terms crispiness and crunchiness, although often used interchangeably, in food science have distinct meanings. The terms crisp, crispy, and crispiness are used to describe a sensation achieved by biting into a crisp food with incisor teeth at the front of the mouth and breaking off a piece of food, causing “product failure” or “product fracture.” A food item can be crispy, fracturable, and brittle, like a potato chip, or crispy on the outside while soft or chewy on the inside. The terms crunchy and crunchiness, on the other hand, are used to describe a sensation achieved by chewing pieces of food, generally 1 inch or smaller in size, between molar teeth at the back of the mouth. Instead of fracturing a piece of food into two pieces, chewing a crunchy piece of food usually causes the food to shatter, or to fracture, into many smaller pieces. Foods that are crunchy can be crunchy throughout, or may have crunchy, fracturable pieces distributed throughout the food to cause a sensation of crunchiness. “Crunchiness” can also be expressed by sensory scientists as “persistence of crisp.” This expresses the fact that, as particles are reduced in size by their grinding between molar teeth, the smaller particles still maintain a “crisp” texture, but on a smaller scale. This is experienced by a large number of multiple simultaneous fractures between molar teeth.

Many foods described as “crunchy” are dry and their crunchiness depends on dryness. Foods having a moisture content of less than about 15% are generally considered dry. In an embodiment, a dry food has a moisture content of less than about 10%. In an embodiment, a dry food has a moisture content of about 2% to about 10%. Examples of crunchy, dry food compositions are described in U.S. Pat. No. 7,507,431 and U.S. 2009/0208609. Examples of dry crunchy foods include, for example, crackers, corn chips, potato chips, some breakfast cereals, candies, pretzels, peanut brittle, and many other snack foods. When the moisture content of such products increases, the products typically lose their crunchiness and become soggy.

In some embodiments, the present disclosure relates to formulations for a food product, particularly a dough based food product such as pizza crust, having a crunchy texture, or a batter-based food product, such as a pancake, or the outer casing of a roll. Throughout this disclosure, both terms “dough” and “batter” are used, but it should be understood that the disclosure and the characteristics of the disclosed food products apply to both dough-based and batter-based foods.

The food product includes a dough having a moisture content of at least 36% by weight. The dough includes texture modifying particles to provide the food product with a crunchy texture. The texture modifying particles comprise a moisture barrier such that the particles retain a crunchy texture in the high moisture environment of the dough and provide a par baked or fully baked food product having a desirable crunchy texture. The crunchy texture of the food product can be maintained during freezing and subsequent finish baking of the food product, if par baked. Alternatively, if the food product is fully baked and then frozen, the food product can be reheated, such as in an oven, in which the warmed food product maintains and exhibits the crunchy texture. Alternatively, if the food product is a thaw-and-serve product, the food product can be thawed and served cold so that the thawed food product maintains and exhibits the crunchy texture.

In some embodiments, the food product comprises a pizza or a pizza crust. Pizza types can be subdivided into a number of different categories, including, for example, “thin crust pizza” and “thick crust pizza”. The crust portion of a thin crust pizza is usually within the range of 3-10 mm thick. Thin crust pizza crusts may be, but are not always, leavened by yeast or chemical means. However, thin crust pizza is often leavened by generation of steam during baking. The crust portion of thick crust pizzas is usually about 10-40 mm thick and leavened with yeast or chemical leavening. Thick crust pizza may also be prepared as a frozen raw dough crust known as a “rising crust,” because the raw dough crust rises significantly when baked from frozen. Some intermediate types of pizza crusts can also be envisioned that may share some qualities of both thin crust and thick crust pizzas. However, for the purposes of this application, the terms thin crust and thick crust are used to capture most typical pizza types.

Thick crust pizzas and breads can be challenging to provide with a crunchy texture because the dough is typically higher in moisture than a thin crust pizza or other food products with a thin crust, particularly if the dough is provided as a frozen product (e.g., frozen pizza or frozen bread) that rises during baking. The longer bake time required for a thick crust pizza or bread allows for more time for steam to penetrate throughout the food product. The present disclosure provides for a way to provide both a thin crust pizza, as well as a thick crust pizza, bread, or other dough-based or batter-based food products with a crunchy texture by the use of texture modifying particles.

The term “texture modifying particles” as used herein refers to particles or pieces of food material that provide the food product its crunchy texture. The particles may vary in size and composition, as further described herein.

The term “crunchy” as used herein refers to the sensation of crunchiness during chewing of a food. The “crunchiness” of a food product is a textural property that can be measured or quantified, for example, by sensory analysis (also known as taste testing), acoustically, or by textural analysis using a texture analyzer device in compression mode by comparison of peak force (or peak load) and time to achieve peak force (i.e., peak time). Various other terms can also be used to express “crunchiness” in sensory analysis, such as “fracturability” and “persistence of crisp.” For example, the term “crunchy” could be used to describe a cereal product such as Wheaties® (available from General Mills in Minneapolis, MN). On the other hand, Wheaties have been described as having “persistence of crisp” in the patent application publication no.: U.S. 2008/0038442 (paragraph [0045]).

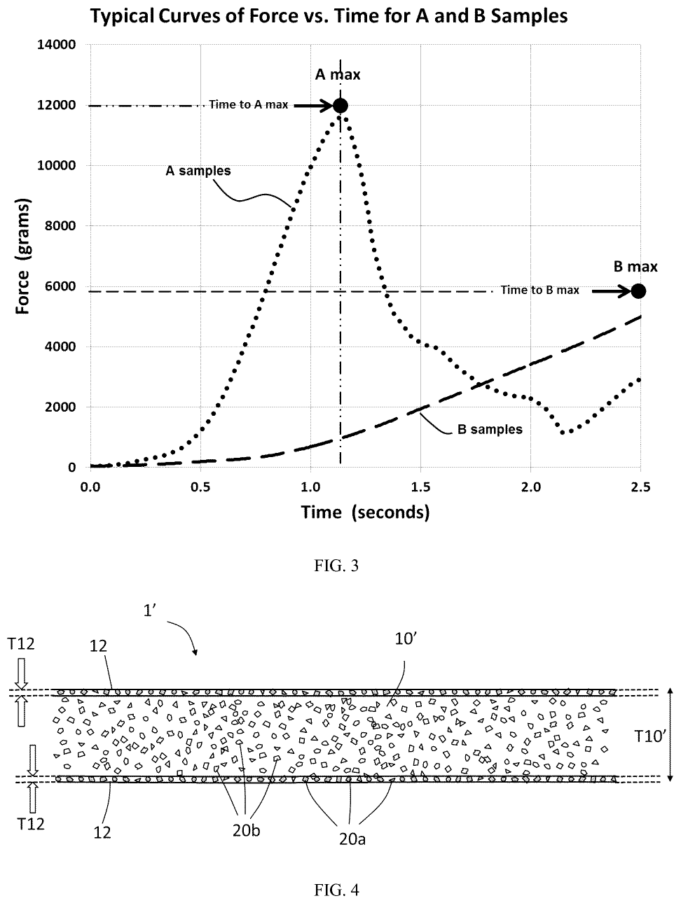

A texture analyzer can be used to analyze many aspects of food products, such as hardness, crunchiness, springiness, cohesiveness, chewiness, resilience, adhesiveness, gumminess, etc. When used in compression mode to measure peak force, the texture analyzer can be used to determine and/or quantify the crunchiness of a food product. The texture analyzer simulates chewing on the food by applying a force to the food that simulates a number of molar teeth biting down and crunching into the food. The force rises to a peak until product structure collapses sharply at multiple small sites simultaneously. The simultaneous fracturing of the food's structure is characteristic of crunchy foods and can be seen as a sharp peak in a graphical presentation of the compression measurement data (see, for example, FIG. 3). As the sample breaks and collapses with multiple tiny fractures, the force drops rapidly, which can be seen as a drop in the force in the graphical presentation. A cumulative force, typically referred to as the peak force or peak load, generally occurs at the point the multiple fractures break rapidly and simultaneously thereby collapsing the structure of the food product.

Suitable texture analyzers are commercially available from, for example, Stable Micro Systems in Godalming, Surrey, England; Texture Technologies in Hamilton, MA; Instron in Norwood, MA; Chatillon in Largo, FL; Lloyd in Bognor Regis, West Sussex, UK; and Brookfield Engineering in Middleboro, MA. The texture analyzer can be outfitted with suitable accessories for crunchiness analysis, such as a Kramer Shear Cell (available, for example, from Instron in Norwood, MA), a TA-25C Crunchiness Fixture Set (available for the TA.XTPlus Texture Analyzer from Texture Technologies Corp in Hamilton, MA), or a ball probe such as the Chip Fracture Rig HDP/CFS (available from Texture Technologies Corp). The Kramer Shear Cell and the Crunchiness Fixture Set both apply a force to the food sample at multiple locations at once, simulating a number of teeth biting down on the food. The Kramer Shear Cell includes linearly arranged vertical plates, whereas the Crunchiness Fixture Set comprises a set of six circularly arranged “cross cut teeth.” The Chip Fracture Rig applies a single probe in what is known as the puncture test, but results in similar data as the multi-point devices.

In a peak force measurement by a texture analyzer, crunchy foods exhibit a higher force and earlier peak time as compared to soft, non-crunchy foods. For example, when tested with a Kramer Shear Cell, a crunchy food may have a peak force (or peak load) above 8000 g (e.g., about 10,000 g), whereas a non-crunchy (e.g., soft, chewy, and/or crumbly) food may have a peak force below 7000 g (e.g., about 5,000 g) or may not exhibit a clear, measurable peak at all. The time to achieve a peak for a crunchy food may be at least 20% shorter than for a non-crunchy food. For example, the peak time for a crunchy food can be in the range of about 0.5 to about 2.2 s, or from about 0.7 s to about 2.1 s, or from about 0.9 s to about 2.0 s, or from about 1.0 s to about 1.9 s; and for a non-crunchy food above about 2.2 s, or about 2.1 s, or about 2.0 s, or about 1.9 s. The absolute numbers will vary depending on the experimental set-up (e.g., equipment used and sample size and type and number of layers in the sample), but the relationship between crunchy and non-crunchy will remain the same, where crunchy foods exhibit a higher force and earlier peak time than non-crunchy foods.

Various ways of measuring crunchiness are discussed in J. Barclay, Engineering Analysis of Crispy Foods—Project Synopsis, Institution of Mechanical Engineers 2006, available at http://www.imeche.org/docs/default-source/knowledge-process-industries/crispyfoodswinnerfood2006.pdf?sfvrsn=0. In Barclay, test methods that “gave highly reproducible results were carried through to final testing” and included: measurement of Young's modulus by uniaxial compression (analogous to testing peak force with a Kramer Shear Cell), spherical indentation (analogous to testing peak force with a single probe), and 3-point bending; fracture toughness and fracture energy by single edge notch tension; and acoustic measurement by compression plates, spherical probe and artificial teeth. These test methods are alternative methods for determining and quantifying the crunchiness of a food product.

Acoustical measurements of crunchiness can be performed by measuring the sound waves produced by chewing food by human test subjects or with artificial teeth using a microphone. Acoustical measurements of crunchiness have been found to correlate with both mechanical (e.g., Kramer Shear Cell) and sensory methods. For example, Barclay discloses that the peak force coincides with the sound pulse, as the crunchy item produces a “crunchy sound” when it collapses. The sound wave frequency caused by eating crispy foods has been found, for example, to be 5.0 kHz or higher, and the sound wave frequency caused by eating crunchy foods has been found to be from 1.25 to 2.5 kHz (see Dacremont, C., Spectral Composition of Eating Sounds Generated by Crispy, Crunchy and Crackly Foods, J Texture Studies 26(1995)27-43).

A ball probe can also be used to determine and quantify the crunchiness of a food product. See Kawas, M. L., Moreira R. G., Characterization of Product Quality Attributes of Tortilla Chips During the Frying Process, J. Food Eng., 47 (2001) 97-107, p. 99. A similar test method is described by Davies, C., “Chips with Everything”: a Laboratory Exercise for Comparing Subjective and Objective Measurements of Potato Chips, J. of Food Science Education, 4 (2005) 35-40. In the ball probe method, a sample is placed horizontally onto a vertical hollow cylinder (e.g., about 18 mm in diameter), and the ball probe (with, e.g., a 6.3 mm diameter) is brought down onto the sample, resulting in multiple fractures in a crunchy sample.

Texture analysis can also be performed by a taste test utilizing a taste panel. For example, a sensory evaluation can be performed by a panel of expert tasters. Sensory testing of food products has been found to correlate with instrumental analysis, including mechanical and acoustic testing. In Segnini, S. et al., Relationship Between Instrumental and Sensory Analysis of Texture and Color of Potato Chips, J. Texture Studies 30 (1999) 677-690, sensory attributes (including crunchiness) were evaluated by a trained panel and were found to correlate with fracture force measurement, which was used to mechanically evaluate crunchiness. See Segnini at page 677. In Vickers, Z. M., Relationships of Chewing Sounds to Judgments of Crispness, Crunchiness and Hardness, J. Food Sci. 47 (1981) 121-124, various foods were tested by non-expert testers for oral sensations and for auditory evaluation of recorded bite and chew sounds. Vickers determined that there is “a large correlation [r=0.95] and close to one-to-one relationship between crunchiness judged by biting and chewing the food and crunchiness judgments made on the sound alone” (Vickers at page 122). Tunick, M. H., et al., Critical Evaluation of Crispy and Crunchy Textures: A Review, Int'l J. Food Properties 16:5 (2013) 949-963 has also found that the results of sensory testing of food products correlate well with mechanical and acoustic testing.

In performing a sensory evaluation, crunchiness of a food can be evaluated against a comparative sample or between a number of samples. The testers can evaluate crunchiness on a numeric scale, such as a percentage scale (see Example 1 below), a scale from 1-10, from 1-15, or a 9-point hedonic scale. Such measures have been found to correlate well with instrumental measurements (see, for example, Segnini et al., 1999). The 9-point hedonic scale is an example of a verbal scale that can be used to evaluate sensory parameters (see, for example, the Society of Sensory Professionals; more information available at www.sensorysociety.org). Other verbal scales include, for example, scales of slightly-moderately-extremely (see, for example, Vickers, 1981), or not crunchy-somewhat crunchy-moderately crunchy-very crunchy-extremely crunchy. A screening test may also evaluate samples as simply crunchy-not crunchy.

Sensory analysis can be performed by a tasting panel that can comprise trained expert tasters or laymen. Testing services of third-party expert tasting panels are available for hire from specialized testing companies, such as Sensory Spectrum in New Providence, NJ (www.sensoryspectrum.com).

According to an embodiment of the present formulation and method, texture modifying particles are distributed throughout the dough and are baked into the food product, providing the food product with a crunchy texture. The formulation and method result in a food product with a crunchy texture that is maintained throughout freezing, thawing, and reheating. The food product can also maintain a crunchy texture after the addition of a topping and/or a filling.

The crunchy texture of the food product can be measured by a texture analyzer in compression mode using, for example, a Kramer Shear Cell to determine a peak load and time to achieve peak load (i.e., peak time). According to at least some embodiments, the peak load for the food products disclosed herein is at least about 8000 g, 8500 g, 9000 g, 9500 g, or 10000 g, and the peak time is less than about 2.5 s, about 2.2 s, about 2.0 s, about 1.8 s, or about 1.5 s. In some embodiments the peak load is from about 8000 g to about 16000 g, from about 8500 g to about 15000 g, or from about 9000 g to about 14500 g, or from about 9500 g to about 14000 g, or from about 10000 to about 13500 g, and occurs from about 0.4 to about 2 s, from about 0.5 to about 1.75 s, or from about 0.6 to about 1.5 s of testing. The texture analyzer results may vary, for example, based on the type of food product and/or the thickness of the dough. For example, a pizza crust may yield a different result than a pie crust, or a crust with a thickness of 20 mm or 10 mm may yield a different result than a crust with a thickness of 4 mm. However, a food product prepared according to the disclosed method and comprising texture modifying particles according to the present disclosure exhibits a higher peak load and shorter peak time than a food product that is otherwise similar (i.e., is of similar type and thickness) but does not include the texture modifying particles.

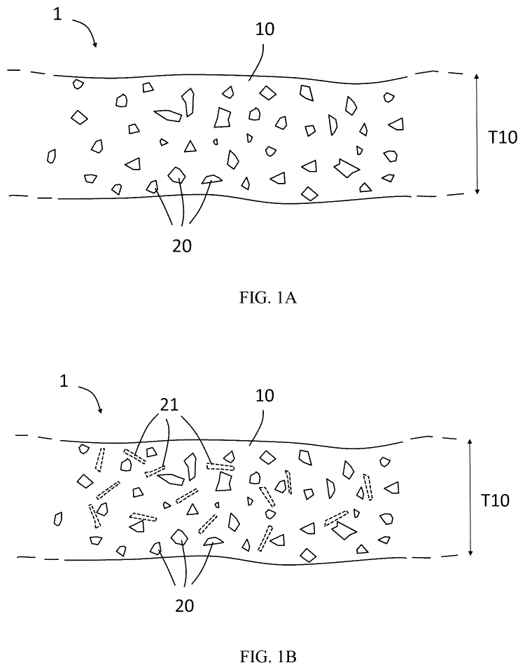

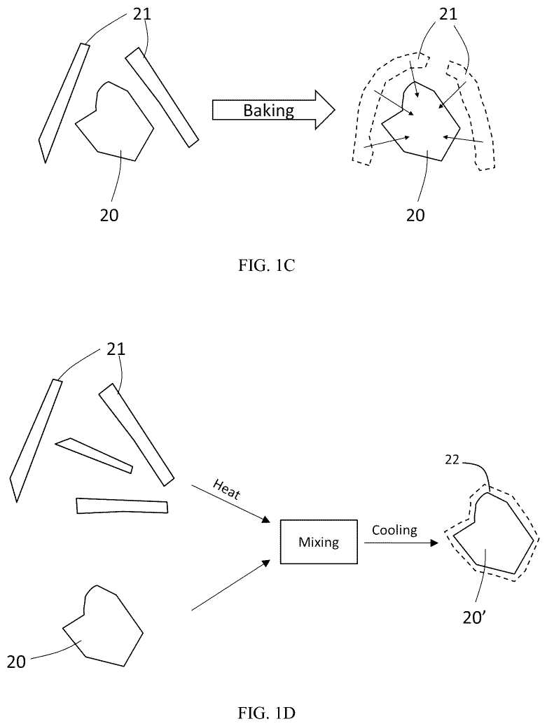

FIGS. 1A and 1B show schematic cross sectional views of a food product 1 according to the present disclosure. According to some embodiments, the food product 1 comprises a main body 10 (e.g., a crust) with a thickness T10, where texture modifying particles 20 are distributed throughout a matrix of the main body 10. The size and amount of the texture modifying particles 20 may vary. However, according to an embodiment, the size and amount of the texture modifying particles 20 are such that the texture modifying particles 20 provide the food product 1 with a crunchy texture. The food product 1 may optionally comprise fat chips 21, as shown in FIG. 1B. In a preferred embodiment, the texture modifying particles 20 provide the food product 1 with a crunchy texture that is maintained throughout freezing and/or finish baking of the food product 1.

According to some embodiments, the food product has a dough-based matrix, and the texture modifying particles are dispersed throughout the matrix as shown in FIGS. 1A and 1B. According to an exemplary embodiment, the dough-based matrix comprises a pizza crust or a bread loaf. According to other embodiments, the dough-based matrix comprises a stuffed pocket crust, a filled sandwich crust, a pie crust, or other crust. For example, the food product may be a pizza crust having a thickness of about 2 to about 12 mm, or about 3 to about 10 mm, or about 3 to about 8 mm, or about 3 to about 6 mm, where the texture modifying particles are dispersed throughout the crust, thus providing the crust with a crunchy texture. The food product can be further topped with toppings or filled with a filling.

In another embodiment, the food product is a pizza crust having a thickness of about 10 to about 40 mm, or about 12 to about 30 mm, or about 14 to about 25 mm, where the texture modifying particles are dispersed throughout the crust but maintain their crunchy texture only near the outer surface of the crust, or are dispersed only throughout an outer layer of the crust.

According to some embodiments, as shown in FIGS. 4-6B, the food product 1′ comprises two sensory zones: a crunchy portion 12 and a non-crunchy portion 16. The texture modifying particles 20 may be dispersed throughout the matrix of the food product 1′, but only maintain their crunchy texture within the crunchy portion 12. Texture modifying particles 20 are shown as crunchy texture modifying particles 20a within the crunchy portion 12. In the non-crunchy portion 16 of the food product, the texture modifying particles 20 may become softer during preparation of the food product and may become substantially unnoticeable when consumed. The texture modifying particles 20 are shown as non-crunchy texture modifying particles 20b within the non-crunchy portion 16. The crunchy portion 12 may be an outer layer of the food product that surrounds or covers an inner non-crunchy portion 16.

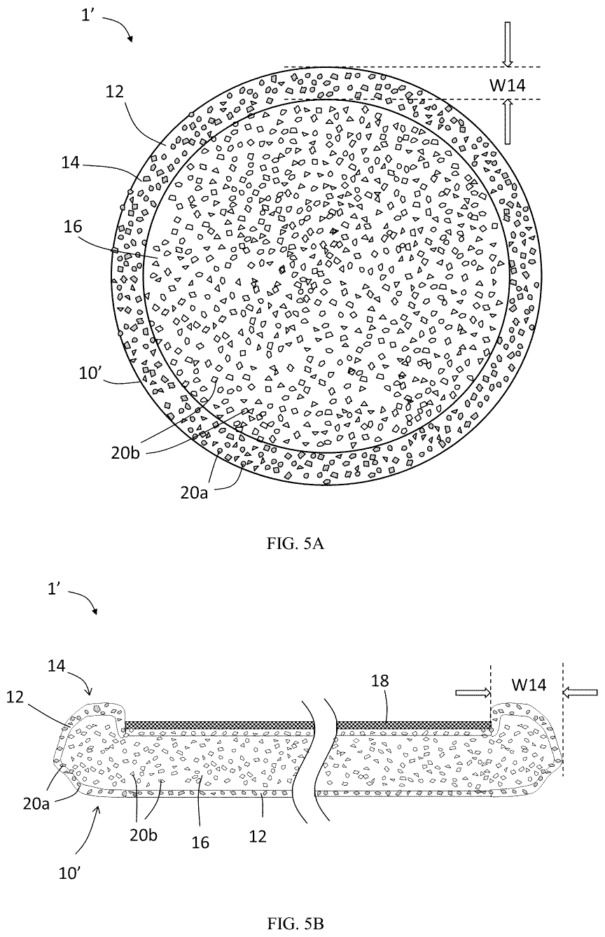

In one embodiment, the food product 1′ comprises a thick crust pizza, and the crunchy portion 12 of the crust 10′ comprises a bottom layer of the pizza crust and a portion (e.g., adjacent to the outer surface) of the rim 14 of the pizza crust. As shown in FIGS. 5A and 5B, the rim 14 may extend from the outer edge of the pizza and have a width W14 of about 5 to about 35 mm, or about 8 to about 25 mm. The non-crunchy portion 16 may comprise the portion of the crust 10′ surrounded by the crunchy portion 12 and/or covered by toppings 18. The non-crunchy portion 16 covered by toppings 18 or surrounded by a crunchy portion 12 at the rim 14 may be soft, springy, and bread like, and may comprise a crunchy portion 12 as a bottom layer.

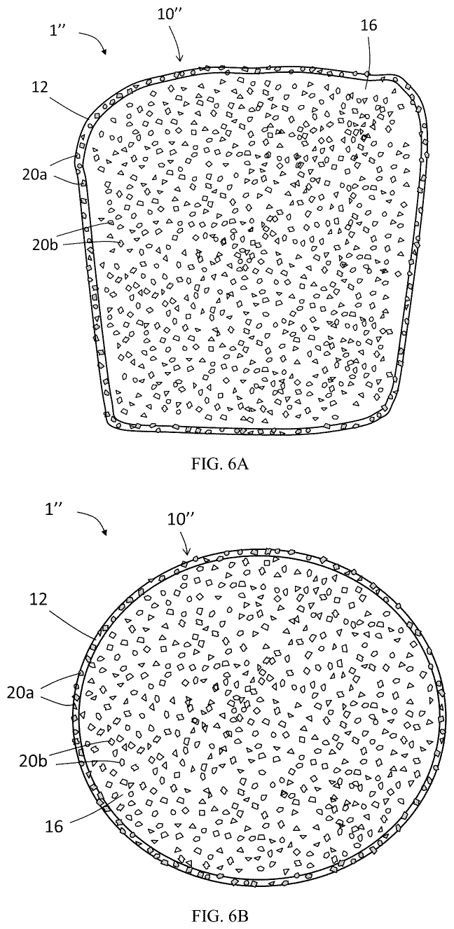

In another embodiment, the food product 1″ comprises bread, and the crunchy portion 12 comprises the outer surface of the bread as shown in FIGS. 6A and 6B. The bread may be a flat bread or a loaf that may be baked into sandwich bread (e.g., a loaf baked in a pan) (FIG. 6A), boule (FIG. 6B), baguette, Italian bread, rolls, buns, bread sticks, pup loaves, etc. The non-crunchy portion 16 (i.e., “crumb”) is located in the center portion of the bread, surrounded by an outer layer comprising the crunchy portion 12. The bread may have any suitable shape and size. Typical breads vary from 60 to 250 mm in width and from 50 to 150 mm in height, although great variations in dimensions are possible, such as with flat breads that may only be a few millimeters thick, or with baguettes that may be 500 mm long.

The crunchy portion 12 may have a thickness of about 1 to about 12 mm, or about 1 to about 9 mm, or about 1 to about 6 mm, or about 1 to about 3 mm, where the texture modifying particles 20a are dispersed throughout the crunchy portion 12, thus providing the food product 1′, 1″ with a crunchy texture.

According to some embodiments, the addition of texture modifying particles can be adjusted based on attributes of the dough to provide a finished food product having the desired amount of crunch. Without wishing to be bound to a particular theory, it is believed that the formulas of the invention provide a balance between the amount of moisture in the matrix, the ability of the moisture to migrate from the matrix to the environment, the ability of the moisture to migrate into the texture modifying particles, and the ability of the texture modifying particles to resist the migration of the moisture. For example, the thickness of the matrix contributes to the amount of moisture and to the ability of the moisture to escape into the environment during baking. Both the thickness and moisture content of the matrix, and the type, amount, and particle size of the texture modifying particles may be considered in designing the different elements of the food product. For example, a thinner matrix (having a smaller thickness T10) may be combined with a lower inclusion and/or smaller particle size of texture modifying particles, whereas a thicker matrix may be combined with a higher concentration and/or a larger particle size of texture modifying particles. In one exemplary embodiment, the food composition comprises a dough matrix having a thickness of about 3 to about 6 mm and about 15 to about 17% by weight of texture modifying particles having a particle size of about 1 to about 3 mm. In another exemplary embodiment, the food composition comprises a dough matrix having a thickness of about 7 to about 9 mm and about 17 to about 19% by weight of texture modifying particles having a particle size of about 3 to about 6 mm. In yet another exemplary embodiment, the food composition includes a crunchy portion that comprises about 20 to about 80% by weight of the food composition, and the crunchy portion has a thickness of about 2 to about 10 mm and comprises about 15 to about 20% by weight of texture modifying particles having a particle size of about 1 to about 5 mm.

In at least one embodiment, the food product comprises a pizza crust. In particular, the food product may comprise a par baked pizza crust. The pizza crust may be either a thin crust or a thick crust. In other embodiments the food product comprises a pastry, a pie, a wrap, a dough pouch, a filled pocket, or another baked food product comprising a crust or casing. The texture of the food product is characterized by texture modifying particles distributed throughout the dough portion of the food product that provides the food product with the desired crunchy texture. In an embodiment, texture modifying particles are distributed throughout a matrix of a pizza crust or a bread and provide the pizza crust or a crunchy portion of the pizza crust or bread with a crunchy texture.

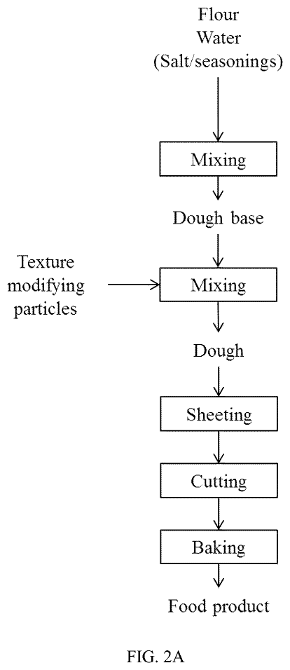

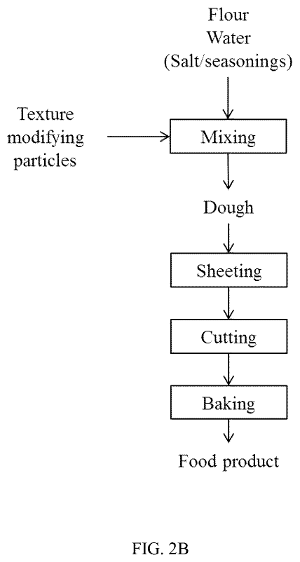

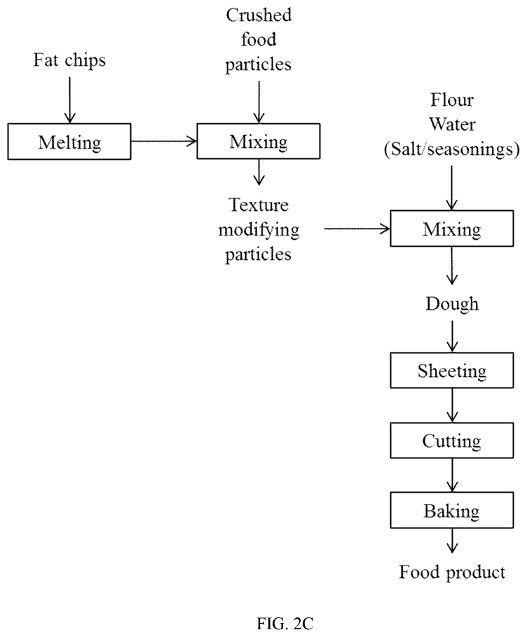

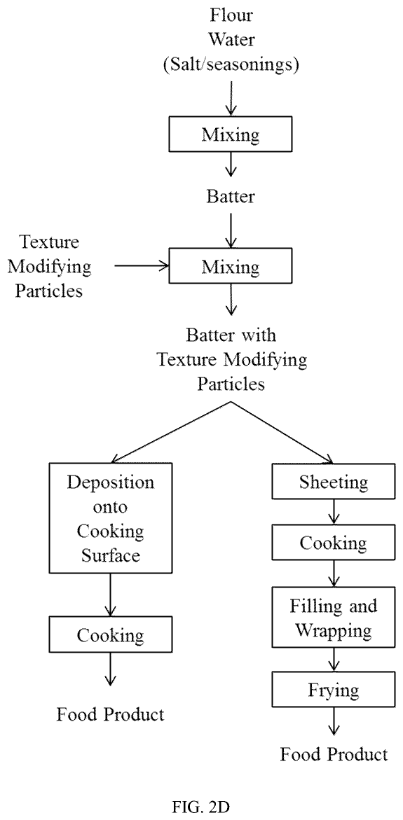

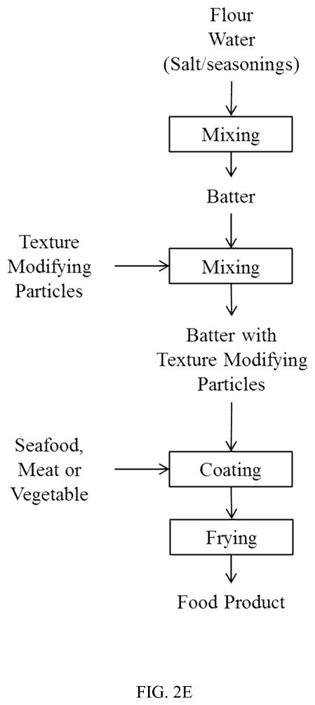

At least in some embodiments, the food product is prepared by preparing a dough base; mixing texture modifying particles into the dough base; forming the dough into a desired shape (e.g., by sheeting and cutting); and baking the dough. A basic flow diagram of the method is shown in FIG. 2A. In an alternative embodiment, the texture modifying particles are added and mixed together with other dough ingredients in one step, as shown in FIG. 2B. The composition of the dough (i.e., the ingredients and their relative amounts) can be varied based on the desired food product. Typically, a dough base for a pizza crust comprises water, flour, salt, and optionally fats, leavener, flavorants, preservatives, or combinations thereof.

According to an embodiment, the dough base comprises an aqueous liquid, such as water. The dough base may comprise, for example, at least about 10, 15, 20, 25, 30, or 31% aqueous liquid by weight. The dough base may comprise less than about 60, 55, 50, 45, 40, or 37% aqueous liquid by weight. According to some embodiments, the dough base comprises about 10 to about 60% water by weight, about 15 to about 55% water by weight, about 20 to about 50% water by weight, about 25 to about 45% water by weight, about 30 to about 40% water by weight, or about 31 to about 37% water by weight. In one embodiment, the dough base comprises about 32%, about 33%, or about 34% water by weight. The aqueous liquid may also comprise another liquid, such as milk or other dairy-based liquids (e.g., whey), broth, or a vegetable or legume based liquid, such as juice, soy milk, almond milk, etc. These amounts are understood to refer to added liquid. Some amount of moisture is also added in the form of the flour, as the moisture content of flour (e.g., wheat flour) may average about 10 to about 15% moisture by weight.

According to an embodiment, the dough base comprises flour, such as grain flour (e.g., wheat, oat, barley, rye, rice, quinoa, millet, sorghum, triticale, sesame, flax, hemp, poppy, chia, and the like). Examples of flours include but are not limited to wheat flour, barley flour, buckwheat flour, corn flour, corn meal, spelt flour, soy flour, millet flour, flaxseed flour, potato flour, potato starch flour, quinoa flour, rice flour, rye flour, sorghum flour, tapioca flour, and combinations thereof. In preferred embodiments, the flour includes wheat flour. In some preferred embodiments, the flour comprises 50% or more of wheat flour. In some embodiments, at least a portion of the flour is whole grain flour. The total amount of flour in the dough base depends on the desired moisture level of the dough and the intended food product. The dough base may comprise, for example, at least about 25, 30, 34, 36, or 37% flour by weight. The dough base may comprise less than about 70, 60, 50, 45, or 40% flour by weight. According to some embodiments, the dough base comprises about 25 to about 70% flour by weight, about 30 to about 60% flour by weight, about 34 to about 50% flour by weight, about 36 to about 45% flour by weight, about 37 to about 40%, about 41 to about 51%, about 43 to about 49%, or about 45 to about 48% flour by weight. In one embodiment, the dough base comprises about 39%, or about 45% flour by weight.

According to another embodiment, the food product is a batter-based food product. Batter-based food products generally may include pancakes, an outer casing of a roll (e.g., a Chinese spring roll, egg roll, or other filled roll or wrap), or a coating of a battered and fried food. The batter can be prepare by mixing liquid (e.g., water), flour, salt, and other batter ingredients together; mixing texture modifying particles into the batter; forming the batter with the texture modifying particles into a desired shape (e.g., by deposition onto a baking surface, by sheeting, or by coating); and baking or frying the batter. A batter formulated for making pancakes or crepes can be deposited directly onto a hot baking surface and baked into the finished product on the baking surface. A batter prepared for making a roll can be sheeted, cooked, and wrapped around the filling, and then fried to produce the finished product. A batter prepared for acting as a coating for another food product (e.g., a vegetable or meat) can be used for dipping the other food product in the batter prior to frying.

In some embodiments, the food product is prepared by preparing a batter; mixing texture modifying particles into the batter; forming the batter into a desired shape (e.g., by deposition onto a baking surface, by sheeting, or by coating); and baking or frying the batter. A basic flow diagram of the method is shown in FIGS. 2D and 2E. In an alternative embodiment, the texture modifying particles are added and mixed together with other batter ingredients in one step, similar to the method shown in FIG. 2B. The composition of the batter (i.e., the ingredients and their relative amounts) can be varied based on the desired food product. Typically, a batter comprises water, flour, salt, and optionally fats, leavener, flavorants, preservatives, or combinations thereof.

Similar liquids and flour can be used to prepare the batter as can be used in the dough composition. According to an embodiment, the batter comprises an aqueous liquid, such as water. The batter may comprise, for example, at least about 25, 30, 35, or 39% aqueous liquid by weight. The batter may comprise less than about 55, 50, 45, or 39% aqueous liquid by weight. According to some embodiments, the batter comprises about 20 to about 60% water by weight, about 25 to about 55% water by weight, about 30 to about 50% water by weight, about 35 to about 45% water by weight, about 30 to about 42% water by weight, or about 35 to about 40% water by weight. In one embodiment, the batter comprises about 39% water by weight.

The batter may comprise, for example, at least about 20, 26, 30, or 32% flour by weight. The batter may comprise less than about 50, 45, 40, or 32% flour by weight. According to some embodiments, the batter comprises about 20 to about 55% flour by weight, about 25 to about 50% flour by weight, about 30 to about 45% flour by weight, or about 32 to about 40% flour by weight. In one embodiment, the batter comprises about 32% flour by weight.

According to some embodiments, the dough base or batter comprises fats, such as oils, hard fats, and mixtures thereof. Examples of oils include but are not limited to canola oil, rapeseed oil, sunflower seed oil, peanut oil, coconut oil, soybean oil, and the like. Examples of hard fats include but are not limited to butter, vegetable shortening, lard, and the like. Fats used herein refer to added fats, excluding fats that may be found in, e.g., flour. The dough base or batter may comprise, for example, at least about 0.1, 1, 2, 3, 4, 5, 6, 7, 8, 10, or 12% fat by weight. The dough base or batter may comprise less than about 16, 14, 12, 10, 8, 6, 4, or 2% fat by weight. For example, the dough base or batter may comprise about 0.1 to about 16% fat by weight, about 1 to about 14% fat by weight, about 2 to about 12% fat by weight, about 3 to about 10% fat by weight, about 3 to about 8% fat by weight, about 3 to about 6% fat by weight, about 0.1 to about 4% fat by weight, about 0.1 to about 2% fat by weight, about 4 to about 10% fat by weight, about 5 to about 12% fat by weight, about 6 to about 14% fat by weight, about 7 to about 16% fat by weight, about 8 to about 16% fat by weight, about 10 to about 16% fat by weight, or about 12 to about 16% fat by weight.

The fat may be a combination of hard fat and oil. For example, for each 1 part of oil, the dough base or batter may comprise at least 1, 2, 3, 4, 5, 6, 8, or 10 parts of hard fat; or for each 1 part of hard fat, the dough base or batter may comprise at least 1, 2, 3, 4, 5, 6, 8, or 10 parts of oil. In some embodiments the dough base or batter may comprise about 0.1 to about 5% oil and about 1 to about 8% hard fat, or about 0.5 to about 4% oil and about 3 to about 6% hard fat. In one embodiment, the dough base or batter comprises about 1 part of oil and about 4 parts of hard fat, where the total amount of fats is about 9 to about 10% by weight, comprising about 2% by weight oil and about 7 to about 8% by weight hard fat. In another embodiment, the dough base or batter comprises about 1 to about 2% oil and about 5 to about 6% hard fat. After the dough is formed, the surface of the dough may be brushed or sprayed with additional fat, such as oil. The additional oil may comprise about 0.1 to about 6%, about 0.5 to about 5%, about 1 to about 4%, or about 2 to about 3% by weight of the final product.

According to embodiments, the dough base or batter may comprise salt and other flavoring ingredients. Examples of salt include but are not limited to sodium salts, potassium salts, magnesium salts, manganese salts, and mixtures thereof. Commercially available salts include but are not limited to table salt, iodized table salt, kosher table salt, sea salt, fleur de sel, smoked salt, and finishing salt. The dough base or batter may comprise, for example, at least about 0.1, 0.5, 0.75, 1.0, 1.25, 1.5, 1.75, or 2.0% salt by weight. The dough base or batter may comprise less than about 3.5, 3.0, 2.5, 2.0, 1.75, 1.5, 1.25, or 1.0% salt by weight. For example, the dough base or batter may comprise about 0.1 to about 3.5% salt by weight, about 0.5 to about 3.0% salt by weight, about 0.5 to about 2.5% salt by weight, about 0.5 to about 1.75% salt by weight, about 0.5 to about 1.5% salt by weight, about 0.75 to about 2.5% salt by weight, about 1.0 to about 3.0% salt by weight, about 1.25 to about 3.0% salt by weight, about 1.5 to about 3.0% salt by weight, about 1.75 to about 3.0% salt by weight, or about 2.0 to about 3.5% salt by weight. Other flavoring ingredients may include seasonings such as herbs, spices, tomato, garlic, pepper, honey, mustard, barbeque, ranch, onion, bacon, cheddar cheese, parmesan, and the like. The dough base or batter may comprise, for example, from 0 to about 8% or from about 1 to about 4% other flavoring ingredients by weight.

Leaveners can be added to provide leavening of the dough or batter. Alternatively the dough or batter can be made without an added leavener, taking advantage of steam formation within the dough during baking. The leavener can be chosen based on the targeted end product, and may include, for example, yeast, cultures, baking soda (sodium bicarbonate), baker's ammonia, baking powder, and the like. A suitable leavening amount depends on the end product. For example, the dough base for a pizza dough may include 0 to about 8% leavener by weight, or about 1 to about 6% leavener by weight. The dough base for a pastry may comprise a combination of leaveners, such as baking soda and baking powder.

The dough base or batter may also comprise one or more sweeteners. Suitable sweeteners include, for example, sugar, honey, agave nectar, maple syrup, corn syrup, high fructose corn syrup, buckwheat honey, and the like. Examples of sugar include but are not limited to cane sugar, brown sugar, granulates, powdered sugar, raw sugar, fructose, dextrose, and combinations thereof. The dough base or batter may also include an acidifier, such as vinegar, cider vinegar, or food grade mineral acids.

In some embodiments, some or all of the ingredients for the dough base or batter are mixed together prior to adding the texture modifying particles. In other embodiments, the texture modifying particles are added to the dough base or batter ingredients and mixed together.

The texture modifying particles may include any suitable food ingredient that has a particle size of at least 0.1, 0.2, 0.3, 0.5, 0.75, 1.0, or 1.5 mm, or no more than about 14, 12, 10, 8, 7, 6, 5, or 4 mm. The texture modifying particles can be uniform or non-uniform in size. The term particle size is used here to refer to a largest cross dimension of the particle. The texture modifying particles may have a particle size between about 0.1 to about 14 mm, about 0.1 to about 12 mm, about 0.1 to about 10 mm, about 0.1 to about 8 mm, about 0.1 to about 6 mm, about 0.1 to about 5 mm, about 0.2 to about 12 mm, about 0.3 to about 10 mm, about 0.5 to about 8 mm, about 0.75 to about 7 mm, about 1 to about 6 mm, about 1 to about 5 mm, or about 1 to about 4 mm. In an embodiment, the texture modifying particles are non-uniform in size with particle sizes varying, for example, between about 0.1 to about 10 mm, or between about 0.2 to about 8 mm, or between about 0.5 to about 5 mm.

The texture modifying particles may be prepared from any suitable food product. The texture modifying particles may be prepared by baking, frying, extrusion, or any other suitable process, for use in the food product of the present disclosure, or may be prepared by breaking apart or crushing prepared foods into particles that have a suitable texture to provide the desired crunchy texture in the finished food. Extruded texture modifying particles can be made from grains or other suitable ingredients, such as wheat, oat, barley, rye, rice, corn, quinoa, millet, sorghum, triticale, sesame, flax, hemp, poppy, chia, buckwheat, spelt, soy flour, potato flour, potato starch flour, tapioca flour, and combinations thereof. The texture modifying particles may include whole grains or other ingredients that provide nutritional benefits. The texture modifying particles may be additionally coated with a layer of fat to provide resistance against moisture penetration. Extruded texture modifying particles are commercially available from, for example, Cereal Ingredients Inc. in Leavenworth, KS, and SK Foods International in Fargo, ND.

Examples of prepared foods that can be used to prepare texture modifying particles include but are not limited to baked, fried, or extruded foods. Foods that may be suitable for the purpose include fried grain or vegetable based products, such as fried grains or grain chips or fried vegetable chips, and extruded food products, such as extruded and baked cereal products, and combinations thereof. Examples of fried grain chips include but are not limited to fried corn chips. Examples of fried grains include but are not limited to fried corn kernels. Examples of fried vegetable chips include but are not limited to fried potato chips, fried carrot chips, fried beet chips, etc. Examples of extruded food products include but are not limited to breakfast cereals and crackers. Examples of commercially available suitable foods include but are not limited to Lay's® potato chips by Frito-Lay, Cape Cod® potato chips by Snyder's-Lance, Kettle Brand® potato chips by Kettle Foods, and Pringles® chips by the Kellog Company; Corn Nuts fried corn kernels by Kraft Food Group; Ruffles® potato chips by Frito-Lay; Doritos® corn chips by Frito-Lay, Mission® corn chips by Mission Foods, Tostitos® corn chips by Frito-Lay, and On the Border® corn chips by Truco; Chex® cereal by General Mills, and Triscuit® crackers by Nabisco. These products comprise a family of products that can be consumed directly out of their packaging container, as is often done. In some cases, they may be eaten with another material, often a liquid, such as Chex® eaten with cold milk for breakfast, or, corn chips with a hot melted cheese sauce for dinner. Even so, this family of products can also be eaten without further preparation and by themselves (e.g., Chex® without milk, or, corn chips with no cheese sauce), if desired.

Additionally there is another family of texture modifying particles that cannot be or typically are not eaten directly out of the package because they are too hard, dry and crunchy. They can be classified as “excessively dry, hard, and crunchy”. If they were consumed directly, their hardness might cause damage to teeth and gums by fracturing teeth and/or cutting gum tissue, or at the very least providing an unpleasant eating experience. However, in many cases, such products cooperate with other products, often aqueous liquids, to make the product and the liquid consumed with it more enjoyable. For example, croutons for consumption in hot soup may be too hard to eat by themselves. However, when eaten in hot soup, they soften somewhat and yet still provide a pleasingly crunchy textured item in the soup, improving the culinary experience of consuming the soup. Similarly, Grape-Nuts® by Post Foods, LLC in St Louis, MO, are so hard and excessively crunchy, that, when eaten directly out of the box, they may possibly damage teeth and injure gums. However, when allowed to sit in a bowl of milk for a few minutes, they soften, and yet remain somewhat crunchy, becoming very pleasing to eat.

In principle, therefore, excessively dry and crunchy particles cooperate with another material, often an aqueous liquid, so that the consumption of both is mutually improved by their interaction. Furthermore, the excessive dry crunchiness is sometimes beneficial to allow any crunchiness at all to persist in a certain food medium after preparation, freezing for sale as a frozen product to consumers, and final heating preparation by customers.

According to an embodiment, the texture modifying particles may comprise products that are generally excessively dry, hard, and crunchy for consumption on their own. Use of texture modifying particles with an excessively dry, hard and crunchy texture may help avoid loss of crunchiness after the food product is frozen and prepared by heating, e.g., by a consumer. This allows a pleasingly crunchy texture to persist until consumption after processing, freezing, and subsequent final heating. According to an embodiment, the texture modifying particles are specifically made to meet size, hardness, porosity, hydrophobicity and crunchiness specifications. The hardness and crunchiness of the particles can be intentionally excessive as they will not be consumed as such, but only after processing in a dough, batter, or other medium, that will soften them enough to make them pleasant to eat and will retain some crunchiness to provide a pleasingly crunchy texture.

The hardness and crunchiness of texture modifying particles may be engineered to optimize end-product qualities. The texture modifying particles may comprise particles made specifically for inclusion into the food products of the present disclosure. Alternatively, existing commercially available products, noted above, that can be eaten directly out of the packaging, can successfully be incorporated as texture modifying particles into dough or batter to create the crunchy products of this disclosure. However, to create and maintain the desired crunchiness in some food products of this disclosure, it may be desirable that texture modifying products are excessively hard, having a texture similar to Grape-Nuts®. For example, when a battered chicken portion is fried to produce a fried chicken product, the chicken meat expels large amounts of steam. This steam may hydrate dry crunchy particles within the batter coating. If at the start, however, the particles are excessively dry, hard, and crunchy, they are able to retain at least some of that crunchy texture after frying, freezing, and reheating of the battered, fried and frozen chicken portion.

According to an embodiment, the texture modifying particles generally comprise a moisture barrier. Moisture in hydrophilic materials, such as food products, tends to equilibrate throughout the material over time. This equilibration process can be accelerated by events that increase moisture diffusion in the material, such as applying heat to a food during baking. Therefore, particles with a lower moisture content that are surrounded by a matrix with a higher moisture content are susceptible to moisture migration into the particles during equilibration, leading to loss of crunchy texture. Without wishing to be bound by a particular theory, it is believed that by providing the texture modifying particles with a moisture barrier, the migration of moisture into the particles can be slowed down or prevented, which helps to maintain the crunchy texture of the particles in the high moisture environment of the dough. The moisture barrier may be external to the particle and/or dispersed within and/or throughout the particle.

The moisture barrier generally comprises fat or gelatinized starch. When gelatinized starch dries, it forms a hard, moisture resistant shell or matrix. In texture modifying particles formed from a food product having a high fat content, such as 20% fat or more as is typical of fried snack foods, or a food product having dried gelatinized starch either as a surface layer or throughout the product, such as is typical of extruded and baked cereal products, the high fat content or dried gelatinized starch can provide the moisture barrier. In an embodiment, the texture modifying particles are formed from a high fat crushed food product, such as fried chips. In such an embodiment, the high fat content of the particles provides a moisture barrier and does not require the addition of fat to the dough and/or coating of the particles with a fat or starch to provide a moisture barrier.

FIG. 1B shows an example of incorporating an external moisture barrier into the food product. The food product 1 comprises texture modifying particles 20 and fat chips 21, dispersed throughout the matrix 10. Without wishing to be bound to a particular theory, it is believed that during par baking of the food product 1, the structure of the texture modifying particles opens up, making the particles more susceptible to migrating water. During baking the fat chips 21 melt and at least some of the melted fat migrates into the texture modifying particles 20, as shown for example in FIG. 1C. The additional fat provides an added moisture barrier and helps deter moisture from migrating into the texture modifying particles thereby maintaining the crunchy texture of the food product.

In an embodiment, the moisture barrier is provided by adding a fat, such as fat chips or semi-solid fats, to the dough in which the texture modifying particles become coated with the fat in the dough. For example, the dough base or batter may comprise chips of hard fat or semi-solid fats, such as tallow, palm oil, coconut oil, lard, butter, chicken fat, or hydrogenated shortening. In an embodiment, the dough base or batter comprises from about 1 to about 20%, or from about 2 to about 15%, or from about 3 to about 12%, or from about 4 to about 10%, or from about 5 to about 9% fat chips by weight of the dough base or batter.

A moisture barrier can also be provided or enhanced by coating the texture modifying particles with a fat and/or gelatinized starch. Examples of suitable fats for coating the texture modifying particles include but are not limited to tallow, palm oil, coconut oil, lard, butter, and chicken fat, various types of hydrogenated shortening, such as different types of margarine and semi-solid shortening (e.g., Crisco®). Examples of suitable starches for coating the texture modifying particles include but are not limited to potato starch, corn starch, wheat starch, sago starch, arrow root starch, sorghum starch, tapioca starch, and rice starch.

In another embodiment, the texture modifying particles can be coated with a fat or starch to form a moisture barrier or to improve an existing moisture barrier before mixing the particles into the dough. For example, coating texture modifying particles that do not contain an adequate moisture barrier can be modified in this manner to be better suited for use in the food product. As shown in FIG. 1D, in some embodiments, fat chips 21 or semi-solid fats are melted at a suitable temperature and melted fat is coated directly onto crushed food particles 20 to form a coating 22 of fat. The coated particles 20′ can be cooled to solidify the coating on the particles. The fat can be heated to about 110 to about 180° F., or to about 120 to about 160° F., or to about 140° F., or to a temperature that is sufficient to melt the fat. After coating the particles, the coated particles can be cooled to about 32 to about 90° F., to about 40 to about 80° F., to about 50 to about 70° F., or to a temperature sufficient to solidify the fat. In some embodiments, the amount of fat used for coating can be about 5 to about 60%, about 8 to about 50%, about 10 to about 40%, or about 15 to about 30% by weight of the coated particles. Coated particles with an enhanced moisture barrier can optionally be stored until the time of future use. The coated particles can be used in the making of the food product as shown in FIG. 2C. In an exemplary embodiment, a crushed baked food product having low moisture, such as a pretzel or a baked chip or cracker, can be coated with a starch or fat to provide particles of the baked food product comprising a moisture barrier.

In another embodiment, the matrix 10 of the food product 1 in FIGS. 1A and 1B is prepared from a batter. A food product with a batter-based matrix can be prepared as shown in FIGS. 2D and 2E. For example, the batter can be deposited onto a cooking surface, as when preparing a pancake or a crepe. Alternatively the batter can be sheeted, cooked, filled with a filling, wrapped, and fried, as when preparing a roll-type food. The batter can also be used to coat other foods (e.g., meat, vegetables, sea food, etc.), as shown in FIG. 2E.

According to embodiments, the texture modifying particles are added to the dough base or batter at an inclusion rate of at least about 4, 6, 8, 10, 12, 14, 16, 18, or 20% by weight of the resulting dough, or at an inclusion rate of no more than about 40, 35, 30, 25, 22, or 20% by weight of the resulting dough. In some embodiments, the dough includes from about 4 to about 20% texture modifying particles by weight, or from about 4 to about 40%, from about 5 to about 18%, from about 5 to about 15%, from about 6 to about 35%, from about 8 to about 30%, from about 10 to about 25%, from about 12 to about 25%, from about 14 to about 25%, from about 16 to about 30%, from about 18 to about 30%, from about 20 to about 30%, or from about 16 to about 20% texture modifying particles by weight.

When the dough is baked into the finished food product, the dough typically loses moisture during the baking process. Therefore, the composition and moisture content of the finished food product depends on the moisture content of the dough and how much moisture is lost during baking. The amount of texture modifying particles in the finished food product can be calculated when the differential in moisture between the dough and the finished food product is known. For example, in an embodiment a dough for a pizza crust may comprise about 35% moisture and about 18% texture modifying particles by weight. The baked crust may comprise about 30% moisture and about 20% texture modifying particles by weight, the reduction in moisture due to moisture loss during baking of the crust. In some embodiments, dough for thick crust pizza or bread is prepared with a lower inclusion rate of texture modifying particles, such as about 4 to about 16% by weight.

The ingredients are mixed into a dough that is then used to form the end product. The dough may be formed into any desired shape. For example, the dough may be sheeted into flat sheets and cut into shapes suitable for making pizza crust, pastries, pouches, etc. In one example the dough is sheeted to circular shapes with a thickness of about 3 to about 10 mm to prepare pizza crusts. Alternatively the dough can be shaped to a slightly irregular shape to have the appearance of an “artisanal” product, or to any other suitable geometric or novelty shape, such as rectangles, squares, stars, triangles, ovals, novelty characters, etc. of a desired size. For example, if the desired end product is a ready-to-eat pizza slice, the dough can be sheeted and cut into triangular shapes. The formed shapes may optionally be further sprinkled with texture modifying particles or, for example, corn meal or a similar product on one side or on both sides. For example, from about 1 to about 5%, or from about 2 to about 4%, or from about 2.5 to about 3.5% of texture modifying particles or corn meal by weight of the sheeted dough may be added by sprinkling. If the shapes are sprinkled on one side only, the shapes may be inverted so that the sprinkled side faces downward. The shapes may be brushed with oil or another fat, or with milk or egg wash. The shapes may be baked in any suitable type of oven and at a suitable temperature for the desired end product. For example, the dough may be par baked at a high temperature for from about 1 to about 10, from about 2 to about 7, or from about 3 to about 4 minutes, and then cooled, packaged, and frozen. Examples of suitable par-baking temperatures include about 450, 475, 500, 525, or 550° F. The frozen food product may be thawed and/or heated (e.g., by a consumer) to prepare the food product for consumption.

For example, to prepare a frozen pizza, the dough is shaped into the form of a pizza crust that may be par baked at a high temperature for from about 3 to about 4 minutes, and then cooled, packaged, and frozen. The pizza crusts can be par baked at, for example, about 500° F. Following par baking, the crust can be frozen, packaged in multiple crust packaging, and shipped to a location for topping, packaging, and shipment to retail stores. A thick crust pizza may be frozen without par baking.

Alternatively, the crusts are immediately topped with sauce, cheese, and other suitable toppings to form a pizza product. A variety of typically tomato based sauces, and a variety of cheeses and cheese blends can be used in combination with toppings selected from meat sources, fish sources, vegetable sources, or fruit sources or other typical topping materials. Pizza sauces can include a variety of ingredients including tomato portions, tomato sauce, tomato paste, and seasonings including salt and spices. Cheeses can include mozzarella, Romano, Parmesan, jack and others. Commonly, cheeses in the form of shaved, crumbled or string form derived from mozzarella, Romano, Parmesan, provolone and whole milk or non-pasteurized cheeses can be used. Cheeses and cheese blends can be used both in the form of blended materials wherein two or more cheeses are blended and then applied to the crust. However, cheeses can also be added to the crust in layers without premixing.

Premium quality meats, including Italian sausages, pepperoni, prosciutto, and seafoods such as shrimp, mussels, etc. can be used to form the pizza product. Vegetarian pizzas can also be made including vegetables including spinach, mushrooms, onions, green peppers, etc. Fruit materials can also be used on the pizzas, both in a vegetarian and non-vegetarian form. Examples of fruit materials include pineapples, apples, etc. Examples of pizza products comprising the crust of the disclosure include Italian style pepperoni pizzas with a blended cheese topping; Italian cheese pizzas having no other meat toppings but optionally including vegetable add-ons; classic supreme pizzas including pepperoni, Italian sausage, green pepper, onion, and/or mushrooms; and southwest chicken pizzas including grilled chicken, Mexican salsa, corn, beans, and other Tejano or Mexican seasonings. A spinach and roasted mushroom pizza can also be made using rough-cut spinach and chopped and roasted mushrooms. Lastly, a bacon and blended cheese of Italian origin including mozzarella, Parmesan, and Romano can be made.

The assembled pizza product is then frozen and packaged using conventional methods and shipped to retail outlets. At the retail outlet, the pizzas are maintained in frozen condition in freezer chests for purchase. Consumers can then purchase the frozen pizzas and can maintain them at home in a frozen state until cooked. Commonly, the pizzas are then removed from conventional packaging materials and placed in consumer ovens and cooked at a temperature of 375° F. to 450° F. for 8 to 20 minutes for thin crust pizzas to complete cooking of the dough and to fully cook the cheese, sauce and other toppings. Thick crust pizzas may be baked from frozen or after thawing at about 375° F. to 450° F. for about 15 to 25 minutes.

Exemplary embodiments of food products of the disclosure are shown in Tables 1-3. Tables 1 and 2 show exemplary dough formulations of the present invention. Table 3 shows exemplary formulations of a finished food product of the disclosure, such as a pizza crust. The formulations in Tables 1-3 do not include toppings or filling that may be applied to the dough or included in the finished food product.

TABLE 1
Food product (dough) composition ranges in weight %

| | Exemplary Formulations | | | | |
|---|---|---|---|---|---|
| Ingredients | A | B | C | D | E |
| Flour | 25-70 | 30-60 | 34-50 | 36-45 | 37-40 |
| Aqueous liquid | 15-55 | 20-50 | 25-45 | 30-40 | 31-37 |
| Fat | 0.1-16 | 1-14 | 2-10 | 3-8 | 4-6 |
| Salt | 0.1-3.5 | 0.5-3 | 0.75-2.5 | 0.75-2 | 0.75-1.5 |
| Leavening | 0-4 | 0-3 | 0-2 | 0-1.5 | 0-1 |
| Protein Isolate | 0-8 | 0-6 | 0-4 | 0-3 | 0-2 |
| Sugar | 0-10 | 0-8 | 0-6 | 0-4 | 0-2 |
| Texture | 4-40 | 6-35 | 8-30 | 12-25 | 16-20 |
| modifying particles | | | | | |
| Seasoning | 0-6 | 0-4 | 0-3 | 0-2 | 0-1 |

TABLE 2
Food product (dough) composition in weight %

| | Exemplary Formulations | | | | |
|---|---|---|---|---|---|
| Ingredients | F | G | H | I | J |
| Wheat Flour | 37-41 | 35-39 | 30-34 | 25-29 | 22-26 |
| Whole Wheat Flour | 0-2 | 2-6 | 4-8 | 6-10 | 8-12 |
| Water | 32-36 | 32-37 | 33-37 | 38-42 | 38-42 |
| Shortening | 4-8 | 3-7 | 2-6 | 1-5 | 3-7 |
| Vegetable Oil | 0.5-2.5 | 0-1 | 0.4-2.6 | 1.5-2.8 | 1-3 |
| Salt | 0.5-1.5 | 0.2-1.2 | 0.6-1.6 | 0.8-1.8 | 1.2-2.2 |
| Dry Yeast | 0-2 | 0-1 | — | 0.4-1.4 | 0.2-1.2 |
| Protein Isolate | — | 0-5 | 0-3 | 1-6 | — |
| Sugar | — | 0-3 | — | — | 0-3 |
| Texture modifying particles | 17-21 | 11-15 | 18-22 | 14-18 | 16-20 |
| Seasoning | 0-1 | 0-2 | — | 0-2 | — |
| Cornmeal | — | 1-3 | 0-2 | 1-4 | 0-2 |

TABLE 3
Food product (pizza crust) composition in weight %

| | Exemplary Formulations | | | | |
|---|---|---|---|---|---|
| Ingredients | K | L | M | N | O |
| Wheat Flour | 39-43 | 38-42 | 32-36 | 27-31 | 24-28 |
| Whole Wheat Flour | 0-3 | 2-6 | 4-8 | 6-10 | 9-13 |
| Water | 28-32 | 27-31 | 29-33 | 32-34 | 31-35 |
| Shortening | 4-8 | 3-7 | 2-6 | 1-5 | 3-7 |
| Vegetable Oil | 0.5-2.8 | 0-2 | 0.4-2.9 | 0.8-3.2 | 0.6-4 |
| Salt | 0.5-1.5 | 0.2-1.2 | 0.6-1.6 | 0.8-1.8 | 1.2-2.2 |
| Dry Yeast | 0-2 | 0-1 | — | 0.4-1.4 | 0.2-1.2 |
| Protein Isolate | — | 0-5 | 0-3 | 1-6 | — |
| Sugar | — | 0-3 | — | — | 0-3 |
| Texture modifying particles | 18-22 | 13-17 | 20-24 | 15-19 | 18-22 |
| Seasoning | 0-1 | 0-2 | — | 0-2 | — |
| Cornmeal | — | 1-3 | 0-2 | 1-4 | 0-2 |

The food product may comprise a dough with a higher fat content than is typical of a pizza crust, such as a pastry dough. Such products comprise, for example, pie crusts, stuffed pockets, or other types of pastries. Exemplary dough formulations of such embodiments are shown in Table 4.

TABLE 4
Food product (dough) composition ranges in weight %

| | Exemplary Formulations | | |
|---|---|---|---|
| Ingredients | P | Q | R |
| Flour | 25-70 | 30-60 | 32-40 |
| Aqueous liquid | 6-20 | 5-15 | 4-10 |
| Fat | 15-45 | 20-40 | 22-36 |
| Salt | 0.1-3.5 | 0.1-3 | 0.2-2.5 |
| Leavening | 0-4 | 0-3 | 0-2 |
| Protein Isolate | 0-8 | 0-6 | 0-4 |
| Sugar | 0-20 | 0-15 | 0-10 |
| Texture modifying particles | 4-40 | 6-35 | 8-30 |
| Seasoning | 0-6 | 0-4 | 0-3 |

### EXAMPLES

The following examples are illustrative, and other embodiments are within the scope of the present disclosure.

### Example 1

Inclusions of various texture modifying particles were tested for their ability to produce a thin crust pizza crust having a crunchy texture. Samples A-E were prepared with a first dough base and sample F with a second dough base as shown in Table 5 below. The prepared doughs were sheeted into flat discs, cut into shapes and baked at 400° F. for 5 minutes. The resulting pizza crust samples A-F were analyzed by a three-person expert panel for crunchiness. The results were given as percentages, with 0% representing no crunchiness and 100% representing extreme crunchiness. Results of the three experts were averaged for each sample.

TABLE 5
Dough Formulations

| | First Dough Base | Second Dough Base |
|---|---|---|
| | (Samples A-E) | (Sample F) |
| Enriched hard Wheat Flour/ | 39.25% | 24.25% |
| Wheat Flour | | |
| Whole Wheat Flour | — | 8.04% |
| Water | 33.66% | 38.05% |
| Shortening Flakes | 5.84% | 0.71% |
| Vegetable Oil | 1.50% | 2.13% |
| Sea Salt | — | 0.21% |
| Salt | 1.00% | 0.21% |
| Inactive Dry Yeast | — | 0.85% |
| Soy Protein Isolate | — | 5.05% |
| Sugar | — | 0.85% |
| Texture modifying particles | 18.75% | 17.79% |
| Yellow Cornmeal | — | 1.85% |

The texture modifying particles where formed from A: fried corn chips (Fritos® by Frito-Lay); B: extruded breakfast cereal (Wheat Chex® by General Mills); C: fried flavored corn chips (Doritos® by Frito-Lay); D: fried potato chips (Ruffles® by Frito-Lay); E: extruded flavored cracker (Triscuit® by Nabisco); and F: baked corn chips (Azteca® by Azteca Foods) as described herein. The texture modifying particles added to the dough base had a particle size of about 0.5 to about 5 mm.

The results of the expert taste panel are shown in Table 6 below.

TABLE 6
Crunch evaluation

| | | Inclusion Rate of | |
|---|---|---|---|
| | | Texture modifying | Crunchiness |
| Sample | Texture modifying particles | particles | (%) |
| A | Fried seasoned corn chips | 18.75% | 89.6 |
| B | Extruded breakfast cereal | 18.75% | 80.0 |
| C | Fried flavored corn chips | 18.75% | 70.5 |
| D | Fried potato chips | 18.75% | 60.8 |
| E | Extruded flavored cracker | 18.75% | 50.4 |
| F | Baked corn chips with seasoning | 17.79% | 12.4 |

Texture modifying particles formed from fried chips and extruded cereal and crackers produced crusts that were characterized as “crunchy” (crunchiness over 50%). Texture modifying particles formed from fried corn chips produced a crust having the most crunch. Texture modifying particles formed from baked corn chips produced a product that was characterized as not crunchy, but rather soft and chewy. Unlike the texture modifying particles formed from fried corn chips, extruded breakfast cereal, fried flavored corn chips, fried potato chips, and extruded flavored cracker, the texture modifying particles formed from baked corn chips, which did not include a moisture barrier, absorbed moisture from the dough and became soggy resulting in a crust having a soft and chewy texture.

### Example 2

Thin pizza crusts were produced according to the process of the present disclosure. Two separate dough bases were prepared, to which texture modifying particles were admixed to produce the final dough. The particle size of the texture modifying particles was about 0.4 to 5.0 mm. Samples A1-A93 were prepared by adding 18.75% by weight of texture modifying particles formed from fried seasoned corn chips into the first dough base. Samples B1-B93 were prepared by adding 17.79% by weight of seasoned texture modifying particles formed from baked corn chips into the second dough base. The dough formulations are shown in Table 7 below. The prepared doughs were sheeted into flat discs and par baked at 500° F. in a conveyorized impingement oven (Blodgett model #: MT1820F/AA, commercially available from G. S. Blodgett Corp., in Burlington, VT) to prepare thin crust pizza crusts. The baked pizza crusts were frozen in a first freezing stage, thawed and topped with pizza toppings, and frozen in a second freezing stage.

The pizza crusts were finish baked and then analyzed by a panel of tasters and a texture analyzer (TA-XT-Plus Texture Analyzer available from Stable Micro Systems, Godalming, Surrey, England with HDP/KS5 Kramer Shear Cell) to determine crunchiness of the finished product. The Kramer Shear Cell was outfitted with five mechanical elements representing “quasi molar teeth” of a tester. The texture analyzer was set up to measure compression force between 0.0-2.5 seconds, with a probe descent speed of 2.00 mm/s and a trigger force, upon contacting the sample, of 40.0 g. Two parameters were compared: (1) the maximum compression force measured during the time period, and (2) the time taken to reach the maximum compression force. Seventeen samples of each type (A and B) were tested.

TABLE 7
Dough Formulations

| | First Dough Base | Second Dough Base |
|---|---|---|
| | (Samples A1-A93) | (Samples B1-B93) |
| Enriched hard Wheat Flour/ | 39.25% | 24.25% |
| Wheat Flour | | |
| Whole Wheat Flour | — | 8.04% |
| Water | 33.66% | 38.05% |
| Shortening Flakes | 5.84% | 0.71% |
| Vegetable Oil | 1.50% | 2.13% |
| Sea Salt | — | 0.21% |
| Salt | 1.00% | 0.21% |
| Inactive Dry Yeast | — | 0.85% |
| Soy Protein Isolate | — | 5.05% |
| Sugar | — | 0.85% |
| Crushed Corn Chips | 18.75% | 17.79% |
| Yellow Cornmeal | — | 1.85% |

The results of the texture analyzer testing are shown in Table 8 and in FIG. 3.

TABLE 8
Texture Analyzer Results

| Peak Force in grams force | | | | Time to Peak Force | | | |
|---|---|---|---|---|---|---|---|
| | Peak | | | | Peak | | |
| Sample | (g) | Sample | Peak (g) | Sample | (s) | Sample | Peak (s) |
| A1 | 11641 | B1 | 5258 | A1 | 1.15 | B1 | 2.50 |
| A2 | 7852 | B2 | 9185 | A2 | 2.50 | B2 | 2.10 |
| A3 | 11559 | B3 | 7232 | A3 | 1.57 | B3 | 2.50 |
| A4 | 8213 | B4 | 4981 | A4 | 1.44 | B4 | 2.50 |
| A5 | 12153 | B5 | 6345 | A5 | 1.34 | B5 | 2.50 |
| A6 | 10069 | B6 | 5705 | A6 | 1.26 | B6 | 2.50 |
| A7 | 11693 | B7 | 5815 | A7 | 1.21 | B7 | 2.50 |
| A8 | 14586 | B8 | 3634 | A8 | 1.56 | B8 | 2.50 |
| A9 | 11012 | B9 | 7120 | A9 | 1.57 | B9 | 2.50 |
| A10 | 9704 | B10 | 6776 | A10 | 1.78 | B10 | 2.50 |
| A11 | 15125 | B11 | 4560 | A11 | 1.41 | B11 | 2.50 |
| A12 | 11463 | B12 | 4734 | A12 | 1.67 | B12 | 2.50 |
| A13 | 9797 | B13 | 4442 | A13 | 2.06 | B13 | 2.50 |
| A14 | 7130 | B14 | 4085 | A14 | 2.50 | B14 | 2.50 |
| A15 | 10947 | B15 | 4133 | A15 | 1.26 | B15 | 2.50 |
| A16 | 10946 | B16 | 4300 | A16 | 1.29 | B16 | 2.50 |
| A17 | 8218 | B17 | 455 | A17 | 1.62 | B17 | 2.50 |
| Average | 10712 | Average | 5221 | Average | 1.60 | Average | 2.48 |
| StDev | 2174 | StDev | 1896 | StDev | 0.41 | StDev | 0.10 |

It was found that the average peak force in grams force for samples A1-A17 was 10,712 g with the average time to peak at 1.6 s. These results are consistent with foods characterized as “crunchy” being compressed by molar teeth to produce a crunchiness sensation. Samples B1-B17 did not produce a clear peak in 16 out of 17 samples, as shown in FIG. 3 (the majority of samples B1-B17 exhibited a maximum force but no peak). These samples did not “shatter” or “fracture” quickly because they were softer and more flexible. The maximum force for samples B1-B17 was measured to be 5,221 g and the average time to maximum force was 2.5 s. A statistical analysis provided a p-value of less than 0.05, indicating that the differences between the “A” samples and the “B” samples were statistically significant. FIG. 3 shows a comparison of the force vs. time of a typical “A” sample and “B” sample. Sample A (typical “A” sample shown) is characterized by a peak that was reached relatively quickly, on average at 1.6 s (see TABLE 8 above), and was higher than the peak for sample B, which was reached on average at 2.48 s. The peak for sample A both rose and fell relatively quickly, within about 1 s—in the case of the typical sample shown, between time points 0.5 and 1.5 s. The early rise to a peak and the rapid rise and fall of the peak force is characteristic of crunchy fracturable items tested in the Kramer Shear Cell and like testing devices. Sample B, on the other hand, reached peak force in most cases only after the time period shown (2.5 s). The longer time to rise to peak force is indicative of non-crunchy, non-fracturable foods measured in the same devices.

The data from the texture analyzer shows that texture modifying particles formed from fried corn chips provided a crunchy pizza crust. In contrast, texture modifying particles formed from baked corn chips, which did not include a moisture barrier, produced a soft pizza crust that was not crunchy.

### Example 3

Samples A18-A93 and B18-B93 from Example 2 were evaluated by a third-party testing company, Sensory Spectrum (www.sensoryspectrum.com) of New Providence, NJ, that provided a trained sensory panel. The sensory panel followed ASTM testing procedures detailed in Hootman, R. C., Manual on Descriptive Analysis Testing for Sensory Evaluation, ASTM Manual 13 MNL 13 (1992) 22-34 (chapter 3: Muñoz, A., and Civille, G., The Spectrum Descriptive Analysis Method), available at http://www.astm.org/DIGITAL_LIBRARY/MNL/SOURCE_PAGES/MNL13.htm. The panel was trained and experienced in evaluation of appearance, flavor, and texture of food products, and performed a descriptive analysis of the provided samples.

The samples were evaluated on fracturability and persistence of crisp, and were rated on a 15-point Spectrum Scale, where 0=none and 15=very strong. The term “fracturability” was defined as the force with which a product breaks or fractures (rather than deforms) when the product is chewed with the molar teeth, and the term “persistence of crisp” as the duration the sample remains crispy during mastication.

Samples A18-A93 received an average score of 0.9 for fracturability and 1.0 for persistence of crisp. Samples B18-B93 received an average score of 0.0 for both fracturability and persistence of crisp. Statistical analysis showed that the differences between the sample groups for both attributes were statistically significant at a 95% confidence level. It was therefore concluded that samples A18-A93 were more crunchy based on the evaluation that samples A18-A93 exhibited higher fracturability and persistence of crisp.

### Example 4

Texture modifying particles were tested for their ability to produce a crunchy thin pizza crust. Samples G, H, I, J and K were prepared according to the procedure in Example 1 using the dough formulation shown in Table 9 below. The texture modifying particles were formed by crushing baked pretzel sticks (G), roasted nuts (H), baked snack crackers (I), baked corn chips (J), and fried corn chips (K). The particle sizes of the texture modifying particles were approximately: (G): 0.2-6.0 mm; (H): 0.6-7.0 mm; (I): 0.3-6.0 mm; (J): 0.4-5.0 mm; and (K): 0.5-5.0 mm. The samples were tested by sensory evaluation.

TABLE 9
Dough formulations G-K and corresponding sensory test results

| | |
|---|---|
| | Dough Formula |
| Wheat Flour | 39.25% |
| Water | 33.66% |
| Shortening Flakes | 5.84% |
| Vegetable Oil | 1.50% |
| Salt | 1.00% |
| Texture modifying particles (F-J below) | 18.75% |
| | Sensory Evaluation |
| G: baked pretzel sticks | Not crunchy |
| H: roasted nuts | Not crunchy |
| I: baked snack crackers | Not crunchy |
| J: baked corn chips | Not crunchy |
| K: fried corn chips | Crunchy |

The sensory data indicated that baked dough samples G-K, which included texture modifying particles formed from pretzel sticks, nuts, crackers, and baked chips, did not have a crunchy texture. It was noted that the microstructure of pretzel sticks, crackers and baked chips is porous and open to absorbing water, with little ability to stop water from migrating into the particles to maintain crunchiness. The microstructure of nuts was also amenable to water absorption and the nuts lost their crunchy texture in the dough matrix. In contrast, texture modifying particles formed from fried corn chips provided a crunchy baked dough.

### Example 5

A thin crust pizza crust was prepared according to the formula in TABLE 10 below, with fried corn chips as the texture modifying particles. The crust was par-baked at 450° F. for 2 min and 30 s. The crust was then topped with toppings as shown in TABLE 11. The product was frozen and stored in frozen storage for at least one night. The product was then finish-baked from frozen at 425° F. for 9 min to produce the finished pizza. After cooling, the pizza was evaluated by sensory testing for crunchiness.

TABLE 10
Dough formula

| | Inclusion Rate |
|---|---|
| Enriched hard Wheat Flour/Wheat Flour | 39.25% |
| Water | 33.66% |
| Shortening Flakes | 5.84% |
| Vegetable Oil | 1.50% |
| Salt | 1.00% |
| Crushed Corn Chips | 18.75% |

TABLE 11
Toppings

| | Inclusion Rate |
|---|---|
| Crust | 43% |
| Oil (soy oil) | 1% |
| Cheese sauce | 19% |
| Shredded cheese (mozzarella and cheddar) | 24% |
| Sausage nuggets (pork and beef) | 11% |
| Diced pepper (jalapeno) | 3% |

The pizza crust remained crunchy, even after the addition of high moisture topping ingredients and finish baking of the pizza crust with these high moisture toppings.

### Example 6

A pancake was prepared according to the method of the present disclosure, based upon Aunt Jemima® Buttermilk Pancake and Waffle Mix (available from the Quaker Oats Company in Chicago, IL), to which texture modifying particles were added.

Exemplary pancake formulations X, Y, and Z are shown in TABLE 12 below. Pancake batter according to formula Y and a comparative example with no texture modifying particles were prepared and cooked into pancakes weighing 90 grams. The pancakes were frozen at 5° F. Two pancakes at a time were reheated from frozen for 45 seconds in a 1100 W microwave oven. An expert panel of seven panelists tested the pancakes and compared pancakes of formula Y to pancakes made without texture modifying particles.

TABLE 12
Batter Formulations

| | Exemplary Formulations (%) | | |
|---|---|---|---|
| Ingredients | X | Y | Z |
| Pancake Mix | 25 | 32 | 39 |
| Aqueous liquid | 44 | 39 | 34 |
| Fat | 11 | 10 | 9 |
| Texture modifying particles | 20 | 19 | 18 |
| Total | 100 | 100 | 100 |

The expert panel judged the pancakes with texture modifying particles to be crunchy. Pancakes without texture modifying particles were judged to be not crunchy.

### Example 7

Thick crust pizza crusts were produced according to the process of the present disclosure. Samples T1-T12 were prepared with a dough base and texture modifying particles as shown in TABLE 13. The control sample (T1) was prepared with no texture modifying particles. Samples T2 and T3 were prepared with texture modifying particles TMP1 and TMP1 fat coated, respectively, at an inclusion rate of 5% by weight. Samples T4-T8 were prepared with texture modifying particles TMP1, TMP1 fat coated, TMP 2, TMP2 fat coated, and TMP3, respectively, at an inclusion rate of 10% by weight. Samples T9-T12 were prepared with texture modifying particles TMP1, TMP1 fat coated, TMP 2, and TMP2 fat coated, respectively, at an inclusion rate of 15% by weight.

TMP1 was an extruded whole grain particle with a spherical shape and an average diameter of about 3 mm. TMP2 was an extruded gluten-free whole grain particles with a spherical shape and an average diameter of about 8 mm. TMP3 was an extruded ancient grain particle with an ellipsoid shape and an average diameter of about 6 mm. The texture modifying particles were obtained from Cereal Ingredients Inc.

Some TMP1 and TMP2 particles were coated by a fat layer by melting palm oil shortening at 160° F., coating the particles with the melted fat, and draining excess fat off. The fat-coated particles were allowed to cool to room temperature (about 70° F.). The fat coated TMP1 particles included about 45.5% fat by weight, and the fat coated TMP2 particles about 40.6% fat by weight.

The samples were prepared by mixing the dough in 2000 g batches according to formulations in TABLES 13A-D, using a Hobart A-200T mixer (available from Hobart Manufacturing in Troy, OH) and a two-tined McDuffie Bowl (available from National Manufacturing in Lincoln, NE). The ingredients (other than water and texture modifying particles) were mixed on low for 1 minute. Water was added, and the dough was mixed at a medium speed for three minutes. The texture modified particles were mixed in according to the formulations, except for the control sample (T1), and the dough was mixed again for one minute. The control sample was mixed for the same length of time as the other samples. The dough was sheeted, cut into circles and frozen in a blast freezer for at least 3 hours at −20° F. The frozen crusts were topped with 107 g pizza sauce and 192 g shredded Mozzarella cheese. The topped crusts were again frozen for at least 3 hours at −20° F. Before baking, the pizzas were tempered from −20° F. to 0° F. for at least 12 hours. The pizzas were baked at 400° F. in a residential oven for 20±2 minutes until the cheese and crusts were browned.

TABLE 13
Thick Crust Formulations

| | | Inclusion | Inclusion | Inclusion |
|---|---|---|---|---|
| | | rate | rate | rate |
| | Control | 5% | 10% | 15% |
| Ingredient | T1 | T2, T3 | T4-T8 | T9-T12 |
| Enriched Flour | 22.23% | 23.36% | 26.14% | 27.13% |
| Whole Grain Wheat Flour | 29.36% | 25.63% | 19.48% | 14.66% |
| Water | 35.52% | 33.74% | 33.18% | 32.75% |
| Compressed Yeast | 2.39% | 2.27% | 2.06% | 1.93% |
| Vegetable Oil | 2.39% | 2.27% | 2.06% | 1.93% |
| Granulated Sugar | 2.52% | 2.39% | 2.18% | 2.04% |
| Granulated Salt | 0.64% | 0.60% | 0.55% | 0.52% |
| Non Fat Dry Milk | 2.48% | 2.35% | 2.14% | 2.01% |
| Vital Wheat Gluten | 2.48% | 2.35% | 2.14% | 2.01% |
| Texture modifying | 0.00% | 5.04% | 10.04% | 15.03% |
| particles | | | | |
| Totals | 100.00% | 100.00% | 100.00% | 100.00% |

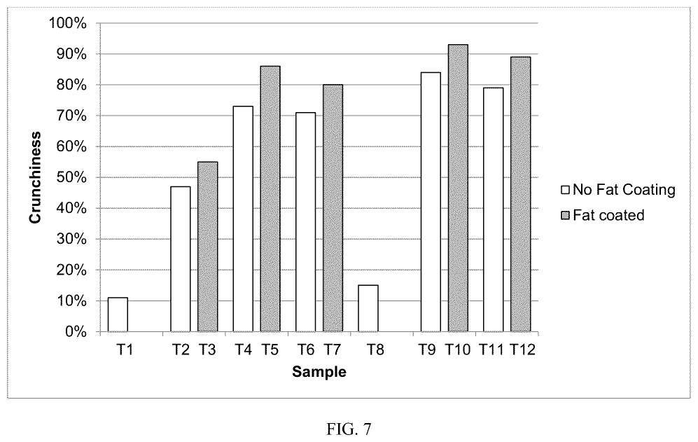

The resulting pizzas were tested for crunchiness by an Expert Panel. The results are shown in TABLE 14 and in FIG. 7.

TABLE 14
Expert Panel Evaluation—Crust Crunchiness

| Sample | Texture Modifying Particles | Inclusion Rate | Crunchiness |
|---|---|---|---|
| T1 | Control | 0% | 11% |
| T2 | TMP1 | 5% | 47% |
| T3 | TMP1 fat coated | 5% | 55% |
| T4 | TMP1 | 10% | 73% |
| T5 | TMP1 fat coated | 10% | 86% |
| T6 | TMP2 | 10% | 71% |
| T7 | TMP2 fat coated | 10% | 80% |
| T8 | TMP3 | 10% | 15% |
| T9 | TMP1 | 15% | 84% |
| T10 | TMP1 fat coated | 15% | 93% |
| T11 | TMP2 | 15% | 79% |
| T12 | TMP2 fat coated | 15% | 89% |

The data indicated that crunchiness was greatly improved by the texture modifying particles TMP1 and TMP2, particularly at the 10 to 15% levels. It was concluded that increase in crunchiness was due to sufficient hardness of the particles and resistance to absorption of moisture. It was also found that coating TMP1 and TMP2 with fat provided further enhancement of crunchiness. It was concluded that the fat coating provided additional resistance to water absorption.

TMP3 provided very limited improvement of crunchiness. It was found that TMP3 was softer, more porous, and flatter, and provided much less resistance to water absorption than TMP1 and TMP2. Fat coating of TMP3 was not tested.

While certain embodiments of the invention have been described, other embodiments may exist. While the specification includes a detailed description, the invention's scope is indicated by the following claims. The specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

1.-47. (canceled)

48. A method for preparing a cooked or baked pizza, the method comprising:
(a) mixing a dough composition comprising flour and water;
(b) incorporating fried or baked chips into the dough composition such that the fried or baked chips are dispersed throughout the dough composition;
(c) shaping the dough composition;
wherein the fried or baked chips are present in the dough body in an amount from about 4% by weight to about 30% by weight of the pizza product.

49. The method of claim 48, further comprising the step of topping the shaped dough composition after step (c).

50. The method of claim 48, wherein the fried or baked chips are corn chips.

51. The method of claim 48, further comprising the step of baking the pizza after step (c).

52. The method of claim 48, wherein the baked or cooked pizza further comprises one or more toppings selected from the group consisting of sauce, cheese, meat, vegetables, fruits, and combinations thereof.

53. The method of claim 48, wherein the crust has a thickness of about 3 mm to about 40 mm.

54. The method of claim 48, wherein the dough composition comprises about 25% to about 70% by weight of flour and about 20% to about 60% by weight of water.

55. The method of claim 48, wherein the dough composition comprises about 0.1% to about 16% by weight of one or more fats.

56. The method of claim 55, wherein the one or more fats comprises oils, hard fats, or combinations thereof.

57. The method of claim 48, wherein the fried or baked chips create a crunchy texture in the cooked or baked pizza.

58. The method of claim 57, wherein a presence or absence of a crunchy texture is determined by sensory analysis, acoustic measurement, textural analysis, or time to achieve peak force.

59. The method of claim 57, wherein the fried or baked chips create a crunchy sensory zone that has a peak force above 8000 g.

60. The method of claim 48, wherein the fried or baked chips have a particle size of about 0.1 to about 14 mm when measured across the greatest cross dimension of the fried or baked chips.

61. The method of claim 48, wherein the fried or baked chips are coated in fat.

62. The method of claim 48, wherein the fat is a hard fat.

63. The method of claim 48, further comprising the step of coating the fried or baked chips with fat before step (b).

64. The method of claim 63, wherein the fried or baked chips are coated by melting the fat to a liquid fat and mixing the liquid fat with the fried or baked chips to produce coated fried or baked chips.

65. The method of claim 48, further comprising the step of freezing the pizza.

66. The method of claim 48, wherein the crust maintains a crunchy texture after reheating the pizza.

67. The method of claim 48, wherein fried or baked chips are flavored.
